(19) United States
(12) Patent Application Publication
(10) Pub. No.: US 2026/0097576 A1
(43) Pub. Date: Apr. 9, 2026

(54) Bimetal Billet and Manufacturing Method Thereof

(71) Applicants: HYUNDAI MOTOR COMPANY, Seoul (KR); Kia Corporation, Seoul (KR)

(72) Inventor: Chang Yeol Yoo, Hwaseong-si (KR)

(73) Assignees: HYUNDAI MOTOR COMPANY, Seoul (KR); Kia Corporation, Seoul (KR)

(21) Appl. No.: 19/081,830

(22) Filed: Mar. 17, 2025

(30) Foreign Application Priority Data
Oct. 8, 2024 (KR) 10-2024-0136347

(51) Int. Cl. B32B 15/01; B32B 1/08; B32B 15/20

(52) U.S. Cl. CPC B32B 15/01; B32B 1/08; B32B 15/20; B32B 2250/02

(57) ABSTRACT

Provided is a bimetal billet and a manufacturing method thereof. The bimetal billet has excellent extrudability and high interfacial bonding strength, with minimized oxidation at the bonding surface between dissimilar metals.

### CROSS-REFERENCE TO RELATED APPLICATION

This present application claims the benefit of priority to Korean Patent Application No. 10-2024-0136347, entitled “BIMETAL BILLET AND MANUFACTURING METHOD THEREOF,” filed on Oct. 8, 2024, in the Korean Intellectual Property Office, the entire disclosure of which is incorporated herein by reference.

### FIELD

The present disclosure relates to a bimetal billet and a manufacturing method thereof.

### BACKGROUND

Magnesium has a specific gravity of 1.74, which is about 64% of aluminum, and a melting point of 650° C., which is similar to aluminum, but has a ductility (elongation) which is less than half that of aluminum. In addition, relative to aluminum, magnesium oxidizes easily at a temperature of 400° C. or higher, has poor extrudability, and can be considered as brittle and can thus be prone to breakages. As such, when aluminum is used in combination with other metals in extrusion processes it can be difficult to set operating conditions such as temperature, speed, and pressure during extrusion, as extrusion conditions typically need to allow for the physical properties and characteristics of each material. Conventional technology typically addresses these challenges by incorporating a method for manufacturing and extruding a bimetal billet. Typically, a bimetal billet is formed by processing the center of an aluminum billet, pressing magnesium into the center of the aluminum billet, and then extruding the billet; however, this incorporates a dimensional problem. In addition, this strategy disadvantageously slows manufacturing as it requires that the processing speed needs to be lowered during extrusion due to the relatively low extrudability of magnesium. In addition, any surface oxidation of magnesium that occurs can reduce the interfacial bonding strength between the aluminum and the magnesium.

Korean Patent Registration No. 10-1501872 relates to a method of casting a bimetal billet by inserting a tube member into a hollow of the metal inside, which may prevent oxidation of the bonding surface between dissimilar metals, but requires an additional process of removing the tube member, and has the disadvantage of not improving extrudability.

Therefore, there is a need to develop, e.g., a bimetal billet with minimized oxidation of the bonding surface between dissimilar metals and that possesses excellent extrudability.

### SUMMARY

The present disclosure addresses the problems of the related art as discussed herein and, in one aspect, the present disclosure provides a bimetal billet with minimized oxidation of the bonding surface between dissimilar metals, and exhibits excellent extrudability, as well as a method of manufacturing such bimetal billet.

In one aspect, the present disclosure provides a bimetal billet comprising: a first cylindrical hollow metal portion; a second cylindrical metal portion sized to fit within, and disposed longitudinally within, the first cylindrical hollow metal portion; and a powder layer disposed between the first cylindrical hollow metal portion and the second cylindrical metal portion, wherein the powder layer comprises titanium oxide (TiO₂) powder, zirconium oxide (ZrO₂) powder, or a combination thereof.

In an example embodiment, the first cylindrical hollow metal portion and the second cylindrical metal portion may each independently comprise at least one metal selected from the group consisting of aluminum, copper, iron, titanium, magnesium, nickel, manganese, chromium, zinc, and lead. In embodiments, the first cylindrical hollow metal portion and the second cylindrical metal portion comprise different metals.

According to an example embodiment of the present disclosure, the first cylindrical hollow metal portion may comprise an aluminum alloy, and the second cylindrical metal portion may comprise a magnesium alloy.

According to an example of the present disclosure, the powder layer and the first cylindrical hollow metal portion may have a thickness ratio of 1:5 to 1:50, and the powder layer and the second cylindrical metal portion may have a thickness ratio of 1:5 to 1:50.

According to an example embodiment of the present disclosure, the powder layer may have a porosity of 0.1% to 0.5%.

According to one aspect of the present disclosure, a bimetal billet can comprise reduced and/or minimized oxidation of the bonding surface between dissimilar metals that comprise the bimetal billet.

In accordance to another aspect of the present disclosure, the bimetal billet comprises excellent extrudability.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a schematic diagram of manufacturing an extrusion component by simultaneously extruding a bimetal billet according to an example of the present disclosure;

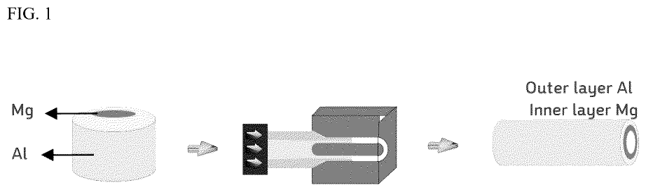

FIG. 2 is a photograph of a bimetal billet manufactured according to Example 1 of the present disclosure; and

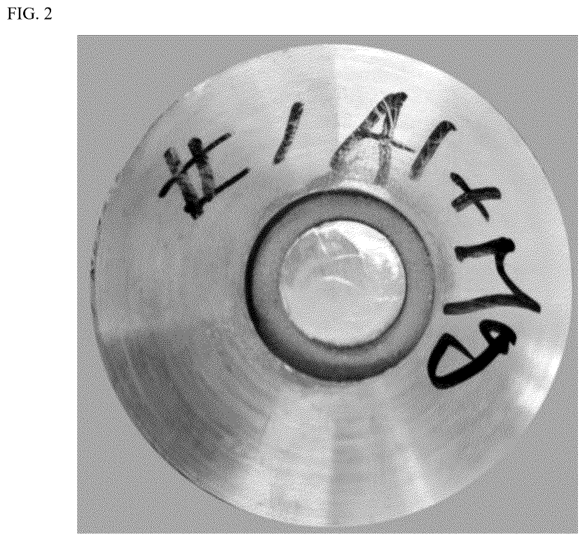

FIG. 3 is cross-sectional photographs of bimetal billets manufactured according to Examples of the present disclosure and Comparative Examples.

### DETAILED DESCRIPTION

Hereinafter, the present disclosure will be described in more detail in an effort to provide illustration and clarity. As such, the following aspects, embodiments, and examples are only a reference for explaining the present disclosure in some detail, and should not be considered as limiting. One of skill in the art will appreciate and understand that the aspects and embodiments in accordance with the disclosure may be implemented in various combinations and alternative forms.

Further, unless otherwise specifically defined, all technical and scientific terms have the same meaning as commonly understood by those skilled in the art to which the present disclosure pertains.

Accordingly, the terminology used herein is merely intended to provide description of illustrative examples and is not intended to limit the present disclosure.

In addition, as used in the specification and the appended claims, the singular forms may be intended to comprise plural forms, unless clearly dictated in the contexts otherwise.

In addition, units used in this disclosure and claims without special mention are based on weight, and for example, units of % or ratio mean wt % or weight ratio, and wt % means wt % of any one component in the entire composition, unless otherwise defined.

Further, unless explicitly described to the contrary, when any part “comprises” any component, it will be understood to further comprise another component rather than excluding another component.

In addition, the numerical ranges used in the present disclosure may comprise lower and upper limits and all values within that range, increments logically derived from the shape and width of the defined range, all doubly defined values, and all possible combinations of upper and lower limits of numerical ranges defined in different shapes. Unless otherwise specifically defined in the specification of the present disclosure, values out of the numerical range that may arise due to experimental error or rounding of values are also comprised in the defined numerical range.

In aspects and embodiments, the present disclosure relates to a bimetal billet and a manufacturing method thereof, which comprises a first cylindrical hollow metal portion; a second cylindrical metal portion disposed longitudinally within the hollow of the first cylindrical hollow metal portion; and a powder layer disposed between the first cylindrical hollow metal portion and the second cylindrical metal portion, in which the powder layer comprises titanium oxide (TiO₂) powder, zirconium oxide (ZrO₂) powder, or a combination thereof.

In example embodiments of the present disclosure, the first cylindrical hollow metal portion and the second cylindrical metal portion may each independently comprise at least one metal selected from the group consisting of aluminum, copper, iron, titanium, magnesium, nickel, manganese, chromium, zinc, and lead. In embodiments, the first and second metal portions do not comprise the same metal. In some specific embodiments, the first cylindrical hollow metal portion may comprise an aluminum alloy, and the second cylindrical metal portion may comprise a magnesium alloy, but the present disclosure is not limited thereto.

In example embodiments of the present disclosure, the powder layer may comprise metal powder, metal oxide powder, or a combination thereof. In some example embodiments of the present disclosure, the metal powder may be titanium powder, aluminum powder, nickel powder, chromium powder, zirconium powder, tungsten powder, molybdenum powder, or a combination thereof. In some example embodiments of the present disclosure, the metal oxide powder may be titanium oxide (TiO₂) powder, zirconium oxide (ZrO₂) powder, magnesium oxide (MgO) powder, cerium oxide (CO₂) powder, chromium oxide (Cr₂O₃) powder, or a combination thereof. In some specific embodiments, the powder layer may comprise titanium oxide powder. In accordance with such example embodiments, at least one of the extrudability and/or the oxidation stability of the bimetal billet may be improved.

In example embodiments of the present disclosure, the powder layer and the first cylindrical hollow metal portion may have a thickness ratio of 1:5 to 1:50, specifically 1:10 to 1:45, and more specifically 1:12 to 1:40 (powder layer:first cylindrical hollow metal portion), and the powder layer and the second cylindrical metal portion may have a thickness ratio of 1:5 to 1:50, specifically 1:10 to 1:45, and more specifically 1:13 to 1:40 (powder layer:second cylindrical metal portion). In such embodiments, the bonding strength between dissimilar metals is sufficiently secured, and the extrusion speed when extruding the billet can be increased. As discussed herein, the thickness of the first cylindrical hollow metal portion can refer to half of a difference between an outer diameter and an inner diameter, the thickness of the second cylindrical metal portion may mean the outer diameter, and the thickness of the powder layer may mean an average shortest distance from the bonding surface of the first cylindrical hollow metal portion to the bonding surface of the second cylindrical metal portion.

In one example embodiment of the present disclosure, the powder layer may have a porosity of 0.1% to 0.5%, specifically 0.15% to 0.2%. In such embodiments, the bimetal billet comprises improved and/or excellent extrudability and/or oxidation stability.

In addition, the present disclosure provides a manufacturing method of the bimetal billet, in accordance with the examples described herein.

Since the description of the bimetal billet that is manufactured by the method falls within the bimetal billet as described above, it will not be repeated.

The manufacturing method of the bimetal billet may comprise manufacturing a first cylindrical hollow metal portion; manufacturing a second cylindrical metal portion; and forming a powder layer between the first cylindrical hollow metal portion and the second cylindrical metal portion.

In one example of the present disclosure, the first cylindrical hollow metal portion may be manufactured by manufacturing a cylindrical metal portion through a general casting method and then processing a center portion thereof to generate a hollow area within the first cylindrical metal portion. The general casting method and the method of processing the center portion can utilize, adopt, and adapt conventional methods. In some embodiments, a centrifugal casting method may be used in addition to the general casting method.

In one example embodiment of the present disclosure, the second cylindrical metal portion may be manufactured by a general casting method or centrifugal casting method.

In one example embodiment of the present disclosure, the powder layer may be formed by injecting powder between the first cylindrical hollow metal portion and the second cylindrical metal portion, pressing the powder with a press, and then heating. In some preferred embodiments, the powder can be added in an excessive amount, and in some specific embodiments, the powder may be injected 110% to 130%, or 115% to 125% of the volume between the first cylindrical hollow metal portion and the second cylindrical metal portion, but is not limited thereto.

Hereinafter, Examples of the present disclosure and Comparative Examples will be described. However, the following Examples are merely illustrative of certain example aspects and embodiments of the present disclosure, and should not be considered as limiting.

### Example 1

An A6063 aluminum alloy was melted, poured into a cylindrical mold having a diameter of 60 mm and a length of 0.5 m, and then solidified to manufacture an aluminum billet. A first cylindrical hollow metal portion was manufactured by processing a central portion of the aluminum billet having a diameter of 21 mm. An AZ31B magnesium alloy was melted, and then poured into a cylindrical mold having a diameter of 20 mm and a length of 0.5 m to manufacture a second cylindrical metal portion. The second cylindrical metal portion was disposed inside the hollow of the first cylindrical hollow metal portion, and TiO₂ powder was injected between the first cylindrical hollow metal portion and the second cylindrical metal portion in an amount of 120% of the original volume and pressed with a press so that the TiO₂ powder was filled without any gaps. Next, the billet was preheated to 400° C. and the TiO₂ powder was bonded to the first cylindrical hollow metal portion and the second cylindrical metal portion to manufacture an aluminum-magnesium bimetal billet including a powder layer having a porosity of 0.18%.

### Example 2

An aluminum-magnesium bimetal billet was manufactured in the same manner as in Example 1, except that ZrO₂ powder (instead of TiO₂ powder) was injected between the first cylindrical hollow metal portion and the second cylindrical metal portion.

### Comparative Example 1

An aluminum-magnesium bimetal billet was manufactured in the same manner as in Example 1, except that an AZ31B magnesium alloy was melted and poured into a cylindrical mold having a diameter of 21 mm and a length of 0.5 m to manufacture a second cylindrical metal portion, and a powder layer was not disposed between the first cylindrical hollow metal portion and the second cylindrical metal portion.

### Comparative Example 2

An aluminum-magnesium bimetal billet was manufactured in the same manner as in Example 1, except that Al₂O₃ powder (instead of TiO₂ powder) was injected between the first cylindrical hollow metal portion and the second cylindrical metal portion.

### Experimental Example 1: Evaluation of Oxidation Stability

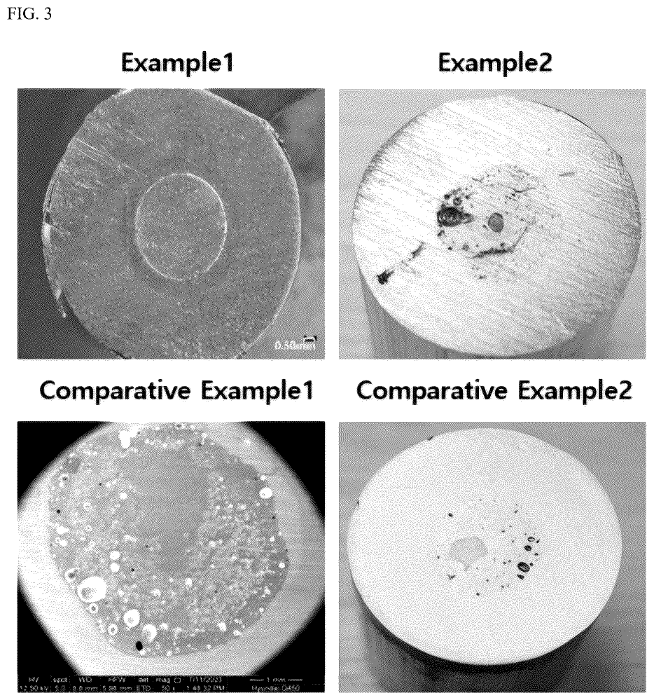

In order to evaluate the oxidation stability, cross-sections shown by cutting the bimetal billets manufactured in Examples and Comparative Examples are shown in FIG. 3, and the number of pores was counted, and the results shown in Table 1.

TABLE 1

| | Pore number (ea/cm²) |
|---|---|
| Example 1 | 0 |
| Example 2 | 8 |
| Comparative Example 1 | 10 |
| Comparative Example 2 | 10 |

As may be seen in FIG. 3 and Table 1, the bimetal billet of Example 2 including a ZrO₂ powder layer showed improved oxidation stability compared to Comparative Example 1, which was a conventional commercial bimetal billet. In addition, it was confirmed that the oxidation stability of Example 1 including a TiO₂ powder layer was excellent because there were no pores in the cross-section.

### Experimental Example 2: Evaluation of Extrudability

In order to evaluate extrudability, the bimetal billets manufactured in Examples and Comparative Examples were put into an extruder and extruded. Specifically, the diameter of an extrusion mold was 13 mm, the mold temperature was 400° C., and the extrusion speed at which an extrusion shape was properly formed was measured, and the results are shown in Table 2.

TABLE 2

| | Extrusion speed (m/s) |
|---|---|
| Example 1 | 5 |
| Example 2 | 0.5 |
| Comparative Example 1 | 0.5 |
| Comparative Example 2 | 0.5 |

As may be confirmed through Table 2, it was confirmed that Example 1 including the TiO₂ powder layer had excellent extrudability.

The data presented above confirms that the bimetal billet including components in accordance with the disclosure including, for example, a powder layer comprising TiO₂, ZrO₂, or a combination thereof, can improve the extrudability and/or the oxidation stability of the bimetal billet described herein.

As those skilled in the art to which the present disclosure pertains will appreciate, various modifications and applications not explicitly illustrated above may be made without departing from the essential characteristics of the embodiments of the present disclosure. For example, each component specifically shown in examples may be modified and implemented. In addition, differences related to these modifications and applications should be construed as being within the scope of the present disclosure including the appended claims.

1. A bimetal billet comprising:
a first cylindrical hollow metal portion comprising an outer surface, an interior surface, and a hollow interior;
a second cylindrical metal portion disposed longitudinally and sized to fit within the hollow interior of the first cylindrical hollow metal portion; and
a powder layer disposed between the interior surface of the first cylindrical hollow metal portion and the second cylindrical metal portion,
wherein the powder layer comprises titanium oxide (TiO₂) powder, zirconium oxide (ZrO₂) powder, or a combination thereof.

2. The bimetal billet of claim 1, wherein the first cylindrical hollow metal portion and the second cylindrical metal portion each independently comprise one or more metal selected from the group consisting of aluminum, copper, iron, titanium, magnesium, nickel, manganese, chromium, zinc, and lead.

3. The bimetal billet of claim 2, wherein the first cylindrical hollow metal portion and the second cylindrical metal portion each comprise a different metal.

4. The bimetal billet of claim 2, wherein the first cylindrical hollow metal portion comprises an aluminum alloy, and the second cylindrical metal portion comprises a magnesium alloy.

5. The bimetal billet of claim 1, wherein the powder layer and the first cylindrical hollow metal portion have a thickness ratio of 1:5 to 1:50, and
the powder layer and the second cylindrical metal portion have a thickness ratio of 1:5 to 1:50.

6. The bimetal billet of claim 1, wherein the powder layer has a porosity of 0.1% to 0.5%.
